(19) United States
(12) Patent Application Publication
(10) Pub. No.: US 2022/0208023 A1
(43) Pub. Date: Jun. 30, 2022

(54) VERB LEARNING METHOD AND SYSTEM FOR SPEAKING FOREIGN LANGUAGE

(71) Applicant: Jeong Tae KIM, Gyeonggi-do (KR)

(72) Inventor: Jeong Tae KIM, Gyeonggi-do (KR)

(21) Appl. No.: 17/606,628

(22) PCT Filed: Apr. 27, 2020
(86) PCT No.: PCT/KR2020/005539

§ 371 Date: Oct. 26, 2021

(30) Foreign Application Priority Data
Apr. 26, 2019 (KR) 10-2019-0049384

(51) Int. Cl. G09B 19/06; G09B 5/06

(52) U.S. Cl. CPC G09B 19/06; G09B 5/06

(57) ABSTRACT

A verb learning method for speaking foreign language is provided. The verb learning method for speaking foreign language through a personal terminal, which has a verb learning function for speaking foreign language and includes a verb learning program for speaking foreign language, a member database, a foreign language database, a necessary meaning filling information database, wherein the verb learning method for speaking foreign language comprises the steps, which are performed by the verb learning program, of: searching the foreign language verb corresponding to a mother tongue verb when the mother tongue verb for speaking it in foreign language is inputted by an input device of the terminal, presenting necessary meaning filling information in the mother tongue verb, and presenting necessary meaning filling information in the foreign language verb corresponding to the necessary meaning filling information in the mother tongue verb.

### BACKGROUND

The present invention relates to a verb learning method and system for speaking foreign language, and more specifically, to a verb learning method and system for speaking foreign language in which when learning foreign language word(s) for speaking foreign language, the learning is performed to overcome the limitations of the foreign language learning method: a translation direction from mother tongue word toward the corresponding foreign language word is progressed and a frame of a sentence is constructed with the patterned common expressions by applying a necessary ‘meaning filling information’ learning process of a verb, thereby helping it substantially to express individual contents which are impossible to be patterned as a sentence. Also, in a translation process of mother tongue-foreign language, when there are two or more foreign language verbs corresponding to a mother tongue verb, a lexical ambiguity problem occurred. In order to solve the problem, in the present invention, the meaning information and a sample sentence corresponding to the foreign language verb are separately proposed by the mother tongue or a type, not a language, such as a picture et cetera, thereby selecting the information corresponding to one's speaking contents by a learner. As a result, a foreign language verb is selected automatically and therefore a lexical disambiguation is progressed.

Recently, an information exchange among nations has been very active by the development of information communication technology and many people today feel the necessity of acquisition of foreign language. Accordingly, a heated wave for learning not only English as the second language that is vital for modern day living and but also various foreign languages has swept across the whole world.

Also, due to the development of the study such as psycholinguistics, cognitive neuroscience, neuroimaging techniques, and cognitive science and so on, detailed processes being occurred in brain have been studied in various points of view. As a result of the study, it is disclosed that mother tongue and foreign language have different processing procedures, respectively, and the mother tongue have influence on processing the foreign language.

Foreign language learning is in fashion around the world and various teaching materials, a web site, a program and so on have been developed and applied to the foreign language learning. However, in the conventional foreign language learning methods, theories about foreign language learning method made by considering the characteristics of English or Japanese such as U.S.A., Japan and so on are imposed and applied mostly, and so the foreign language learning methods are not suitable for Koreans with mother tongue as Korean.

On the other hand, there are several problems in conventional foreign language verb(word) learning methods:

a conventional foreign language word learning method is to memorize the foreign language word and the mother tongue word corresponding to it as a pair, that is, to translate the foreign language word into the mother tongue word and then memorize it. So, although it is suitable for the language action corresponding to ‘understanding’ such as reading or listening of text, it is not suitable for the language action corresponding to ‘production’ such as speaking or writing text. That is, when performing the language action corresponding to production such as speaking foreign language, it is known that the foreign language learners (specially, a novice foreign language learner) make the contents that they want to speak with the mother tongue. According this, the foreign language speaking is not the translation from the foreign language to the mother tongue, but the translation from the mother tongue to the foreign language.

Also, a conventional foreign language word-mother tongue word pair memorization method has weakness: in the translation process of mother tongue verb-foreign language verb, when the foreign language words corresponding to the mother tongue word are two or more, a lexical ambiguity problem occurred because no learning contents about the lexical problem are included in the method. For example, in the foreign language speaking, when a user studies ‘believe’ and ‘trust’ verbs as ‘ [symbol] (mittda) (believe) and ‘ [symbol] (silroehada) (trust)’, only, the user does not know the foreign language word corresponding to ‘ [symbol] (mittda) (believe)’ at various situations when he (or she) wants to speak ‘ [symbol] (mittda) (believe)’ in the foreign language. Unless the lexical ambiguity problem is resolved, it is difficult to select the proper foreign language vocabulary corresponding to the contents that a learner wants to speak and accordingly, it is an obstacle to foreign language speaking.

Also, as a foreign language speaking method, so called, a ‘pattern foreign language’ is known. For instance, as an English speaking method, a foreign language, so called, a ‘pattern English’ is known. According to this method, in the sentences of ‘ [symbol] (Jigeum Gago Sipeoyo). (I'd like to go now)’ or ‘ [symbol] (Jago Sipeoyo). (I'd like to go to sleep)’ or ‘ [symbol] [symbol] .’ (Chingurl Mannago Sipeoyo). (I'd like to meet a friend)’ or ‘ [symbol] [symbol] .’ (Ummawa Iyagihago Sipeoyo). (I'd like to speak with my mother), ‘ [symbol] .’ (˜Hagosipeoyo.) of the common part in Korean corresponds to ‘I'd like to˜’ in English, so a learner memorizes the pattern as the common part. That is, this method is to learn a frame of the patterned sentence, which is used frequently. However, there exists a big obstacle, in this method, when improving an English speaking skill. That is, although a user learns the contents corresponding to a frame of a sentence through the pattern, the user has a big problem to speak the contents that he (or she) wants to speak, (that is, ‘individual meaning elements which cannot be patterned’) such as a ‘˜’ part in English without a separate learning process.

Korean Registered Patent No. 10-1136415 (Registered: Foreign language learning system and method based on cognitive function of learners).

### SUMMARY OF THE INVENTION

In consideration of the above-mentioned circumstances, it is an object of the present invention to provide a verb learning method and system for speaking foreign language.

### Technical Solution

In order to solve problems in conventional techniques as mentioned above, there is provided a verb learning method and system for speaking foreign language in which when learning foreign language words for speaking foreign language, a translation direction is progressed from the mother tongue word toward the corresponding foreign language word, not the pair of foreign language word and mother tongue word, thereby improving a learning effect because contents that you want to speak are made as a mother tongue sentence.

Also, according to another object of the present invention, there is a provided a verb learning method and system for speaking foreign language in which the necessary ‘meaning filling information’ learning process of a verb is developed to overcome limitations of the patterned foreign language learning method, and the learning of necessary ‘meaning filling information’ of the foreign language verb corresponding to the necessary meaning filling information of the mother tongue verb is performed intensively, thereby enhancing a learning effect substantially in a foreign language speaking.

Also, according to another object of the present invention, there is provided a verb learning method and system for speaking foreign language in which in a translation process of mother tongue-foreign language, when there are two or more foreign language verbs corresponding to a mother tongue verb, a lexical ambiguity problem occurred, the meaning information and a sample sentence corresponding to the foreign language verb are separately proposed by mother tongue, thereby selecting a learner the information corresponding to one's speaking contents, and as a result, a foreign language verb is selected automatically and therefore the lexical ambiguity problem is solved and the accuracy of the foreign language speaking through a proper verb use is increased extraordinarily.

### Advantageous Effects

According to the present invention having the above-described configuration, when learning foreign language words for speaking foreign language, a translation direction is progressed from mother tongue word toward the corresponding foreign language word, not a pair of foreign language word and mother tongue word, thereby improving a learning effect because the contents that a user wants to speak are made by a mother tongue sentence.

Also, in a verb learning method and system for speaking foreign language, a necessary ‘meaning filling information’ learning process of the verb is developed to overcome limitations of a patterned foreign language learning method, and the learning of necessary ‘meaning filling information’ of foreign language verb corresponding to the necessary meaning filling information of the mother tongue verb is performed intensively, thereby enhancing a learning effect substantially in the foreign language speaking.

Also, according to a verb learning method and system for speaking foreign language, in a translation process of mother tongue-foreign language, when there are two or more foreign language verbs corresponding to a mother tongue verb, a lexical ambiguity problem occurred, the meaning information and the sample sentence(s) corresponding to the foreign language verb are separately proposed by the mother tongue, thereby selecting a learner the information corresponding to one's speaking contents. As a result, a foreign language verb is selected automatically and therefore a lexical ambiguity problem is solved and the accuracy of the foreign language speaking through a proper verb use is increased extraordinarily.

### BRIEF DESCRIPTION OF DRAWINGS

FIG. 1 to FIG. 21 are interface screens displayed examples of specific learning processes through a display of a smart phone or a personal terminal loaded a foreign language speaking verb learning program in a foreign language speaking verb learning method according to the present invention.

FIG. 22 is a system construction view for performing a foreign language speaking verb learning method according to the present invention.

FIG. 23 is a block construction view of FIG. 22 in a foreign language speaking verb learning method according to the present invention.

### DETAILED DESCRIPTION OF THE INVENTION

In order to accomplish the above object, according to a preferred embodiment of the present invention, there is provided a verb learning method for speaking foreign language through a personal terminal, which has a verb learning function for speaking foreign language and includes a verb learning program for speaking foreign language, a member database, a foreign language database, a necessary meaning filling information database, wherein the verb learning method for speaking foreign language comprises the steps, which are performed by the verb learning program, of: searching the foreign language verb corresponding to a mother tongue verb when the mother tongue verb that a user wants to speak in foreign language is inputted by an input device of the terminal, presenting necessary meaning filling information in the mother tongue verb, and presenting necessary meaning filling information in the foreign language verb corresponding to the necessary meaning filling information in the mother tongue verb.

Also, according to another preferred embodiment of the present invention, there is provided a verb learning method for speaking foreign language through a personal terminal, which has a verb learning function for speaking foreign language and includes a verb learning program for speaking foreign language, a member database, a foreign language database, a necessary meaning filling information database,

wherein the verb learning method for speaking foreign language comprises the steps, which are performed by the verb learning program, of:

searching the foreign language verb corresponding to a mother tongue verb when the mother tongue verb that a user wants to speak in foreign language is inputted through an input device of the terminal,

discriminating whether a lexical ambiguity problem occurred because two or more foreign language verbs corresponding to the mother tongue verb exist,

presenting the meaning and the sample sentence about each candidate foreign language verb corresponding to the mother tongue verb inputted by the learner, if the lexical ambiguity problem occurred,

presenting necessary meaning filling information in the mother tongue verb, if a signal for selecting the contents corresponding the mother tongue's verb is inputted from the learner, and

presenting necessary meaning filling information in the foreign language verb corresponding to the necessary meaning filling information in the mother tongue's verb.

Also, in the verb learning method for speaking foreign language through a personal terminal, wherein the necessary meaning filling information includes a necessary sentence component in the sentence using a verb of the mother tongue, which necessarily must be included when making a sentence with a verb as a predicate, and the necessary meaning filling information in the foreign language verb corresponding to the necessary meaning filling information in the mother tongue verb is presented.

Also, in the verb learning method for speaking foreign language through a personal terminal, wherein the necessary meaning filling information is presented by translating a foreign language word corresponding to the mother tongue word.

Also, in the verb learning method for speaking foreign language through a personal terminal, wherein in the presenting process of the meaning and the sample sentence,

wherein in the presenting process of the meaning and the sample sentence, a type is presented additionally and separately as a non-language type like a picture to directly select a learner who already have known the contents that he (or she) wants to speak, thereby solving a lexical ambiguity problem.

In order to accomplish the above object, according to another preferred embodiment of the present invention, there is provided a verb learning method for speaking foreign language through a personal terminal, which has a verb learning function for speaking foreign language and includes a verb learning program for speaking foreign language, a member database, a foreign language database, a necessary meaning filling information database,

wherein the verb learning method for speaking foreign language comprises the steps, which are performed by the verb learning program, of:

searching the foreign language verb corresponding to a mother tongue verb when the mother tongue verb for speaking it in foreign language is inputted by an input device of the terminal,

discriminating whether a lexical ambiguity problem occurred because a structure of the meaning filling information of the mother tongue verb is two or more,

presenting the meaning filling information structure of the mother tongue as mother tongue, respectively, if the lexical ambiguity problem occurred,

presenting necessary meaning filling information in the mother tongue verb, if a signal for selecting the contents, which a learner wants to speak, corresponding the meaning filling information structure of the mother tongue verb is inputted from the learner, and

presenting necessary meaning filling information in the foreign language verb corresponding to the necessary meaning filling information in the mother tongue verb.

And, there is a program stored to a memory medium which readable by a computer including a verb learning method for speaking foreign language.

In order to accomplish the above object, according to another preferred embodiment of the present invention, there is provided a personal terminal including a verb learning function for speaking foreign language which has a verb learning program for speaking foreign language, a member database, a foreign language database, and a necessary meaning filling information database comprising:

the verb learning program for speaking foreign language, which has a function of searching the foreign language verb corresponding to a mother tongue verb when the mother tongue verb that a learner wants to speak in foreign language is inputted,

wherein the verb learning program includes:

a lexical ambiguity problem processing module for discriminating whether a lexical ambiguity problem occurred because the meaning filling information of the mother tongue verb is two or more,

a necessary meaning filling information processing module for presenting each mother tongue about the meaning filling information of the mother tongue, if the lexical ambiguity problem occurred, which presents necessary meaning filling information in the mother tongue verb, if a signal for selecting the contents corresponding the mother tongue verb is inputted from a learner, and

a foreign language sample sentence matching module for presenting necessary meaning filling information in the foreign language verb corresponding to the necessary meaning filling information in the mother tongue verb.

In order to accomplish the above object, according to another preferred embodiment of the present invention, there is provided a verb learning system for speaking foreign language including a personal terminal, and a server communicated with the personal terminal through a communication network, the server having a verb learning program for speaking foreign language, a member database, a foreign language database, and a necessary meaning filling information database, the verb learning system for speaking foreign language comprising:

the verb learning program for speaking foreign language, which has a function of searching the foreign language verb corresponding to a mother tongue verb when the mother tongue verb for speaking it in foreign language is inputted by the personal terminal,

wherein the verb learning program includes:

a lexical ambiguity problem processing module for discriminating whether a lexical ambiguity problem occurred because the meaning filling information of the mother tongue verb is two or more,

a necessary meaning filling information processing module for presenting each mother tongue about the meaning filling information of the mother tongue to the personal terminal, if the lexical ambiguity problem occurred, which presents necessary meaning filling information in the mother tongue verb to the personal terminal, if a signal for selecting the contents corresponding the mother tongue verb is inputted from a learner by the personal terminal, and

a foreign language sample sentence matching module for presenting necessary meaning filling information in the foreign language verb corresponding to the necessary meaning filling information in the mother tongue verb to the personal terminal.

### MODE FOR INVENTION

The present invention may be altered in various ways and have various embodiments, and will be described with reference to the drawings for illustrating specific embodiments.

However, the present invention is not limited to the specific embodiments, and it will be understood by those skilled in the art that the invention is to cover all modifications, equivalents, and alternatives falling within the spirit and scope of the invention.

Terms used herein are for the purpose of describing specific embodiments only, but are not intended to limit the present invention. A singular form includes a plural form unless the context clearly indicates otherwise. Throughout this specification, it will be understood that the term “comprise” and variations thereof, such as “comprising” and “having”, specify the presence of features, numbers, steps, operations, components, parts, or combinations thereof, described in the specification, but do not preclude the presence or addition of one or more other features, numbers, steps, operations, components, parts, or combinations thereof.

Hereinafter, preferable embodiments of the present invention will be described with reference to the accompanying drawings. Referring to the drawings, wherein like reference characters designate like or corresponding parts throughout the several views, and the same corresponding parts will not be described.

A foreign language speaking verb learning method of the present invention will be characterized:

First, in the foreign language speaking verb learning method of the present invention, when learning foreign language word for speaking foreign language, a translation direction is progressed from mother tongue word toward the corresponding foreign language word, not the pair of foreign language word and mother tongue word. Because the contents that a learner wants to speak are made by the mother tongue sentence, it is suitable that the learning from the mother tongue word toward the foreign language word for speaking foreign language.

Second, the necessary ‘meaning filling information’ learning process of the verb is developed to overcome the limitations of the patterned foreign language learning method. The learning of necessary ‘meaning filling information’ of foreign language verb corresponding to the necessary meaning filling information of the mother tongue verb is performed intensively, thereby enhancing the learning effect substantially in foreign language speaking.

According to this, the necessary ‘meaning filling information’ of the verb is an element which must be included necessarily when making a sentence with the verb as predicate. For example, the Korean verb ‘ [symbol] (Sogaehada) can make a complete sentence as predicate by including elements such as ‘ [symbol] (nuga)’ and ‘ [symbol] (nugurol) and ‘ [symbol] (nuguege)’, such as ‘who’ and ‘whom’ and ‘to whom’ in English sentence. At this time, the information corresponding to [symbol] (nuga)’ and ‘ [symbol] (nugurol) and ‘ [symbol] (nuguege)’ corresponds to the meaning filling information’. In comparison with the words of ‘necessary’, the words to ‘non-necessary’ includes such as ‘ [symbol] (unje)’, and ‘ [symbol] (udiseo), and ‘ [symbol] (we)’ and so on, such as ‘when’ and ‘where’ and ‘why’ in English word, in the example of ‘ [symbol] (Sogaehada)’ and are not necessary to filling the meaning of ‘ [symbol] (Sogaehada)’.

Third, in a translation process of mother tongue-foreign language, when there are two or more foreign language verbs corresponding to a mother tongue verb, a lexical ambiguity problem occurred, the meaning information and a sample sentence corresponding to the foreign language verb are separately proposed by the mother tongue, thereby selecting a learner the information corresponding to one's speaking contents, and as a result, a foreign language verb is selected automatically and therefore the lexical ambiguity problem is solved and the accuracy of the foreign language speaking through the proper verb use is increased superiorly. To solve the lexical ambiguity problem, although the information made by mother tongue, a type such a picture, not language, can be presented.

[Learning Contents Input Process]

Input process-a user inputs the mother tongue verb that a learner wants to speak foreign language.

Search process-a user searches for the foreign language verb corresponding to the mother tongue verb.

Discrimination process-a program discriminates whether a lexical ambiguity problem occurred because two or more foreign language verbs corresponding to the mother tongue verb exist.

Thereafter, the program performs a next step if the lexical ambiguity problem does not occurred.

Also, the program performs a process for solving an ambiguity problem, if the lexical ambiguity problem occurred.

[The Lexical Ambiguity Problem Solving Process]

Presenting process—

when there are two or more candidates of foreign language verbs corresponding to a mother tongue verb inputted by a learner, information to solve the lexical ambiguity problem, not language, can be presented as a type such a picture.

Selection process-when a user selects the contents corresponding to the verb that you want to speak, the program performs a next step.

[The Meaning Filling Information Learning Process]

Presenting process—the program presents the necessary meaning filling information of the mother tongue verb. (At this time, by considering characteristics of the necessary meaning filling information of the foreign language verb, it can be presented by stages from easy level to a difficult level.

After that time, presenting process—the program presents the necessary meaning filling information of the foreign language verb corresponding to the necessary meaning filling information of the mother tongue verb.

[The Learning Contents Review Process]

Presenting process—the program presents the necessary meaning filling information of the mother tongue verb. (At this time, by considering characteristics of the necessary meaning filling information of the foreign language verb, it can be presented by stages from easy level to a difficult level.

After that time, presenting process—the program presents the necessary meaning filling information of the foreign language verb corresponding to the necessary meaning filling information of the mother tongue verb.

After that time, input process-a user discriminates whether the sentence made by a user matches the presented sentence and inputs the discrimination result. In the input process, a user can select ‘0’ button or ‘X’ button showing the display screen. In another input process, the user can touch and draw down the screen when he (or she) know certainly that the sentence made by the user matches the presented sentence. Also, if it is judged that the review is necessary, the user can touch and draw up the screen and any other various input methods can be performed.

After that time, storage process—the error sentences can be saved and applied to the next learning process.

An Embodiment of the Present Invention

Hereinafter, a verb learning method for speaking foreign language according to an embodiment of the present invention will be described with reference to the accompanying drawings.

Hereinafter, in the embodiment of the present invention, the mother tongue is Korean, and the foreign language is English.

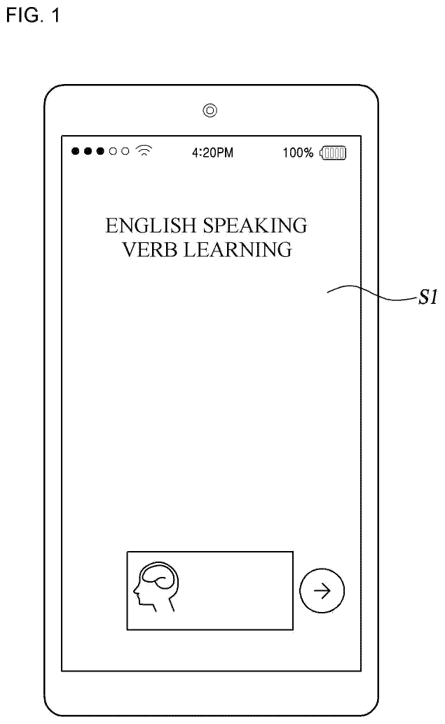

FIG. 1 is an example of an initial interface screen S1 in a foreign language speaking verb learning method according to the present invention. In order to perform this process, a user must download a foreign language verb learning program to one's own smart phone terminal or a personal assistant device such as a PAD. Although it is not shown, thereafter all processes can also be performed on a personal computer PC.

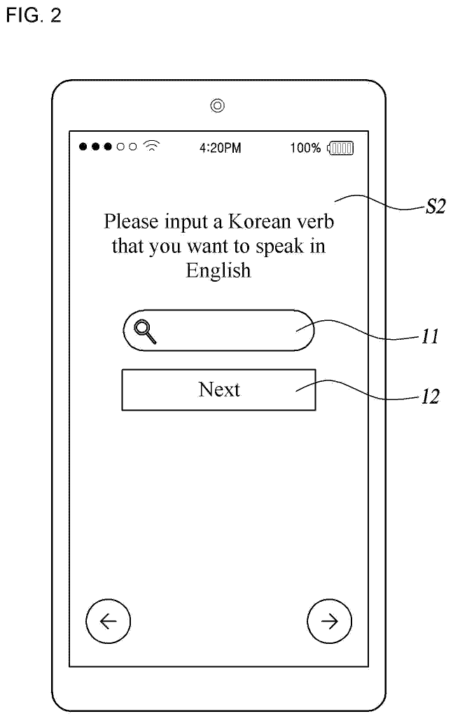

FIG. 2 is an example of an interface screen S2 being displayed after FIG. 1. In the interface screen, a reference number 11 is a word input part, and a reference number 12 is a next step progress button. A user can input a Korean verb in English that you want to speak to the word input part 11.

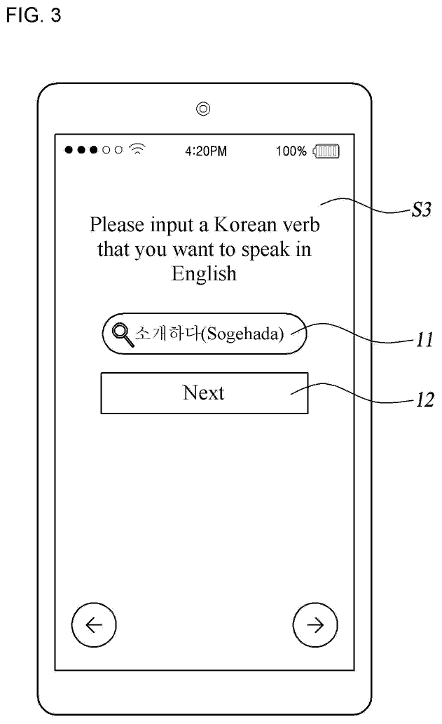

FIG. 3 is an example of an interface screen S3 being displayed after FIG. 2. A user inputs a word such as “ [symbol] (Sogehada)” to the word input part 11.

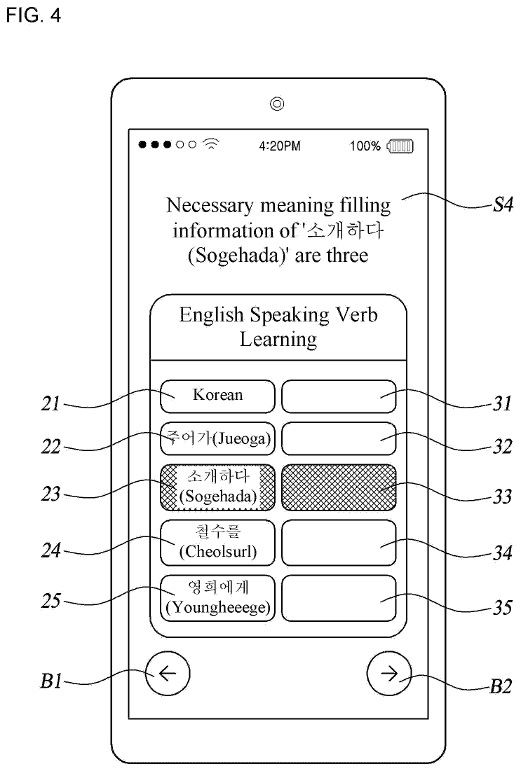

FIG. 4 is an example of an interface screen S4 being displayed after FIG. 3. Through the discrimination based on the word inputted by the user, a program displays a necessary meaning filling information interface screen S4 of the mother tongue verb. In the screen S4, the notice read: the necessary meaning filling information of “ [symbol] (Sogehada)” inputted in FIG. 3 are three.

Also, in the screen S4, a Korean display part 21 and a foreign display part 31 are displayed separately. The word of “ [symbol] (Sogehada)” inputted in FIG. 3 is displayed on an input word display window 23 and the Korean (which means the mother tongue in the present invention) meaning filling information are displayed on each display parts 22, 24, and 25. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

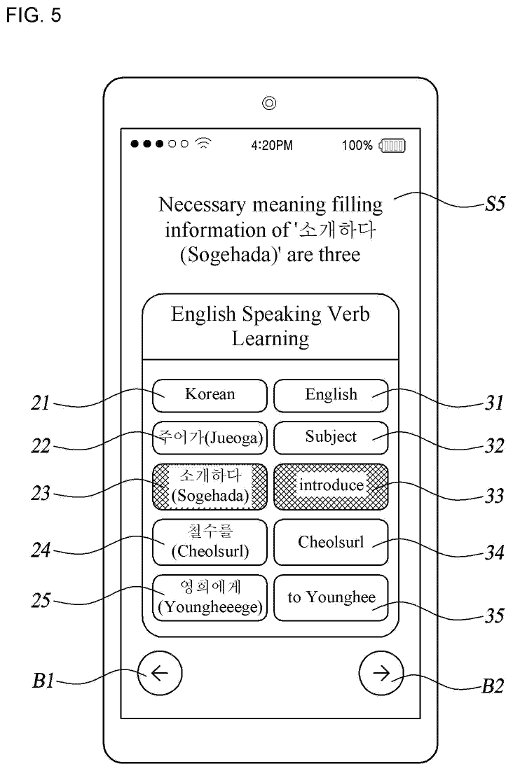

FIG. 5 is an example of an interface screen S5 being displayed after FIG. 4. In the interface screen S5, the foreign language, that is, English verb “introduce” corresponding to “ [symbol] (Sogehada)” inputted in FIG. 3 is displayed (the translation direction is set from the mother tongue word toward the corresponding foreign language word, not the pair of foreign language word and mother tongue word, i.e., the pair of mother tongue word and foreign language word).

Also, the corresponding information are filled in foreign language meaning filling information display parts 32, 34 and 35 corresponding to Korean meaning filling information display parts 22, 24, and 25. At this time, as an example described above, to reduce a burden of a learner, if possible, things which can display in Korean can be displayed in Korean. So, ‘ [symbol] (Juoga)’ is presented to ‘ [symbol] (Jueo)’, ‘ [symbol] (cheolsurl) to ‘ [symbol] (cheolsu)’, and ‘ [symbol] (Youngheeege)’ to ‘to [symbol] (Younghee)’. Also, we can know that the necessary meaning filling information of the foreign language corresponding to the Korean of “ [symbol] (Sogehada)” are three.

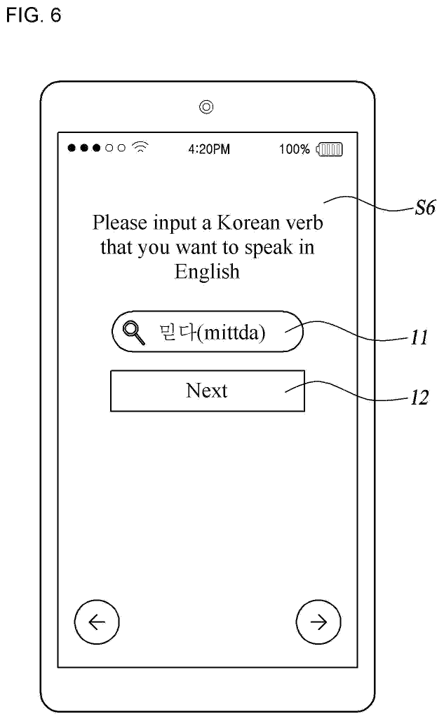

FIG. 6 is an example of an interface screen S6 which is similar to FIG. 2. A user inputs a word of “ [symbol] (mittda)” to the word input part 11.

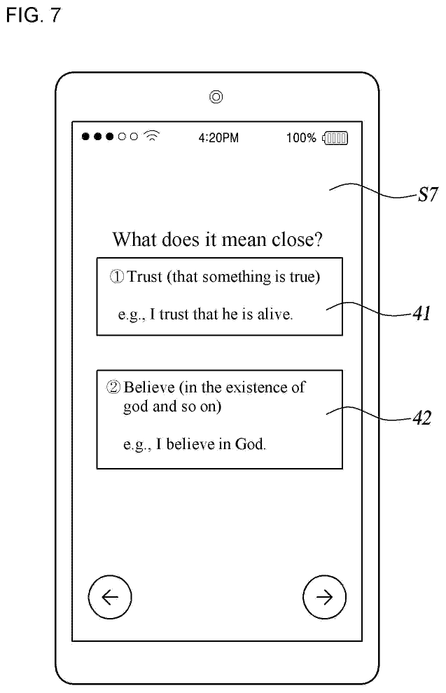

FIG. 7 is an example of an interface screen S7 being displayed after FIG. 6. In case that a user inputs a word of “ [symbol] (mittda)” to the word input part 11, a program discriminates that the lexical ambiguity problem occurred because the foreign language verbs corresponding to the word of “ [symbol] (mittda)” of the mother tongue verb are two or more. Thereafter, the program displays information corresponding to two verbs, respectively, i.e., the meaning and sample sentences regarding to each foreign language corresponding to “ [symbol] (mittda)” of the mother tongue verb to the meaning display parts 41 and 42 (When the foreign language verbs corresponding to the mother tongue verb are two or more, the program discriminates that that the lexical ambiguity problem occurred and then presents an example corresponding to that).

On the other hand, as shown in FIG. 6, when inputting, a user types the first consonant letter or the middle vowel letter of the word that you want to speak, a serviceable list can be displayed automatically (for example, a pop-up window can be displayed), and then select one in the list (not shown).

Also, as shown in FIG. 7, to solve the lexical ambiguity problem, in the screen presented by a program according to the present invention (the screen in which the meaning and sample sentence(s) are presented), when there is no the meaning that a user wants to speak, the user can send a question or request message with a push message (not shown) as a feedback signal.

Also, a user can add one's own word through a user DB addition function to the necessary meaning filling information DB (it may be library data downloaded from a manager computer program server (not shown) according to the present invention or real-time streaming data downloaded through a Network).

Each DB including the member DB according to the present invention and the program may be updated periodically and a learning record, a review record, a quiz game record (when learning a word among the learning contents, wrong answers only may be collected and presented as a quiz type) may be stored and managed by individual.

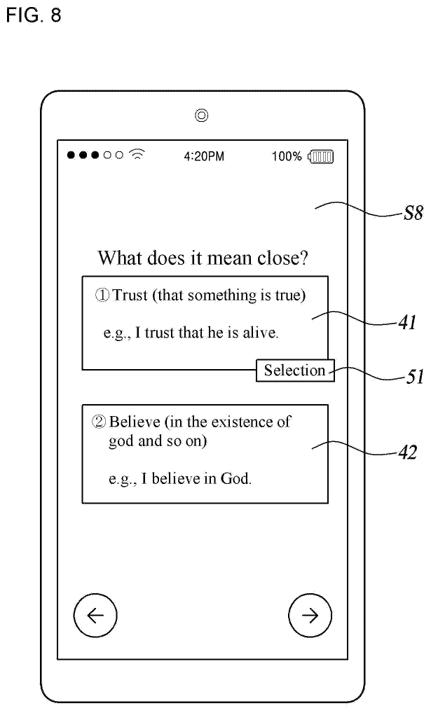

FIG. 8 is an example of an interface screen S8 being displayed after FIG. 7. In case that a user selects one of two meaning display parts 41 and 42 displayed in FIG. 7, a selection part 51 is displayed.

In each interface screen, the function shift can be performed by touch. However, it is not limited in that and various types of the function shift can be performed.

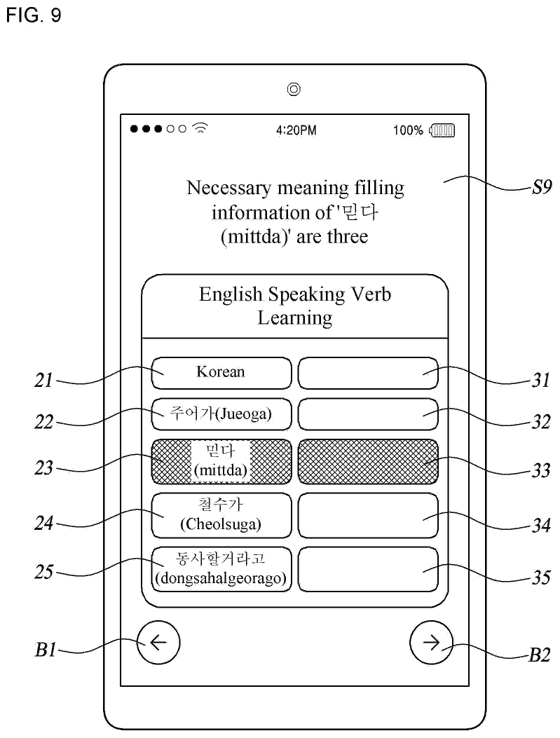

FIG. 9 is an example of an interface screen S9 being displayed after FIG. 8. Through the discrimination based on the word inputted by the user (or a learner), a program displays a necessary meaning filling information interface screen S9 of the mother tongue verb. In the screen S9, the notice read: the necessary meaning filling information of “ [symbol] (mittda)” inputted in FIG. 8 are three.

Also, in the screen S9, a Korean display part 21 and a foreign display part 31 are displayed separately. The word of “ [symbol] (mittda)” inputted in FIG. 8 is displayed on an input word display window 23 and the Korean (which means the mother tongue in the present invention) meaning filling information are displayed on each display parts 22, 24, and 25. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

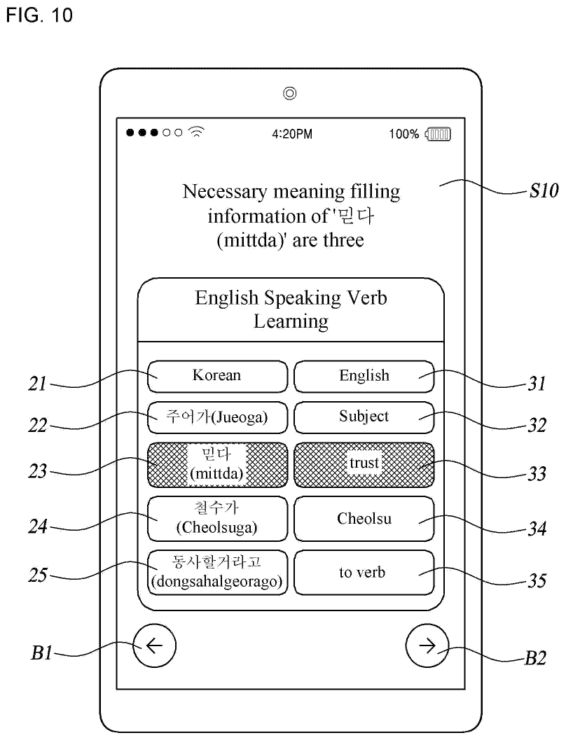

FIG. 10 is an example of an interface screen S10 being displayed after FIG. 9. In the interface screen S10, the foreign language, that is, English verb “trust” corresponding to “ [symbol] (mittda)” inputted in FIG. 6 is displayed (the translation direction is set from the mother tongue word toward the corresponding foreign language word, not the pair of foreign language word and mother tongue word, i.e., the pair of mother tongue word and foreign language word).

Also, the corresponding information are filled in foreign language meaning filling information display parts 32, 34 and 35 corresponding to Korean meaning filling information display parts 22, 24, and 25. At this time, as an example described above, to reduce a burden of a learner, if possible, things which can display in Korean can be displayed in Korean. So, ‘ [symbol] (Juoga)’ is presented to ‘ [symbol] (Jueo)’, ‘ [symbol] (cheolsurl) to ‘ [symbol] (cheolsu)’, and ‘ [symbol] (dongsahal georago)’ to ‘to [symbol] (dongsa)’. Also, we can know that the necessary meaning filling information of the foreign language corresponding to the Korean of “ [symbol] (mittda)” are three.

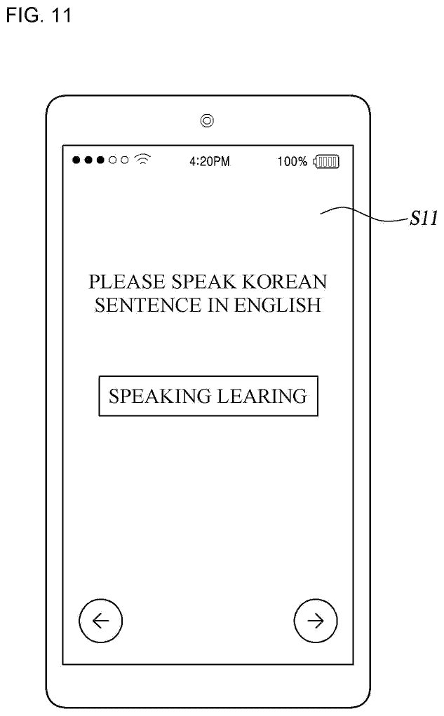

FIG. 11 is an example of an initial interface screen S11 in a foreign language speaking verb learning method according to the present invention. In order to perform this process, a user must download a foreign language verb learning program to one's own smart phone terminal or a personal assistant device such as a PAD. Although it is not shown, thereafter all processes can also be performed on a personal computer PC.

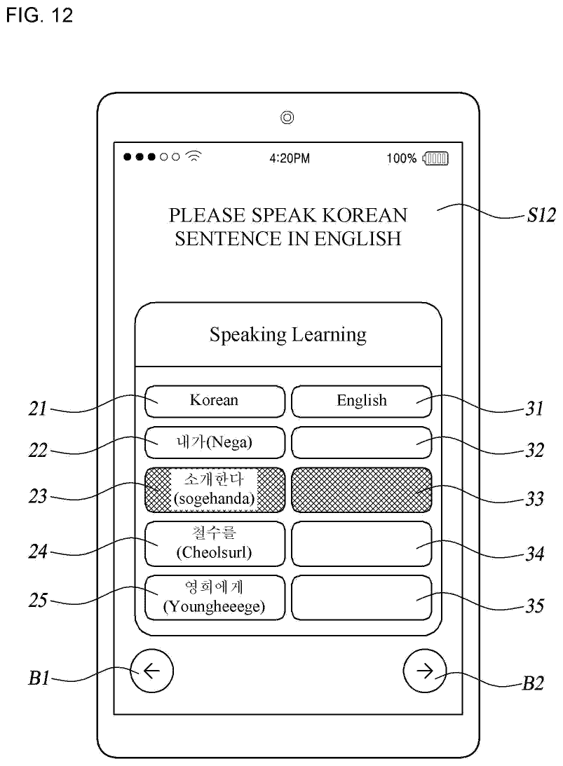

FIG. 12 is an example of an interface screen S12 being displayed after FIG. 11. FIG. 12 is a view similar to FIG. 4 and also because it is a view for speaking practice, a specific word, in this example, the necessary meaning filling information using the word of “ [symbol] (Sogehada)” are displayed. That is, in the screen S12, the word of “ [symbol] (Sogehada)” is displayed on an input word display window 23 and the Korean (which means the mother tongue in the present invention) meaning filling information are displayed on each display parts 22, 24, and 25. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

Although it is not shown, we can know that the meaning filling information are three through the number of the display part. This process had been already explained after FIG. 4 and so the repeated explanation will be omitted.

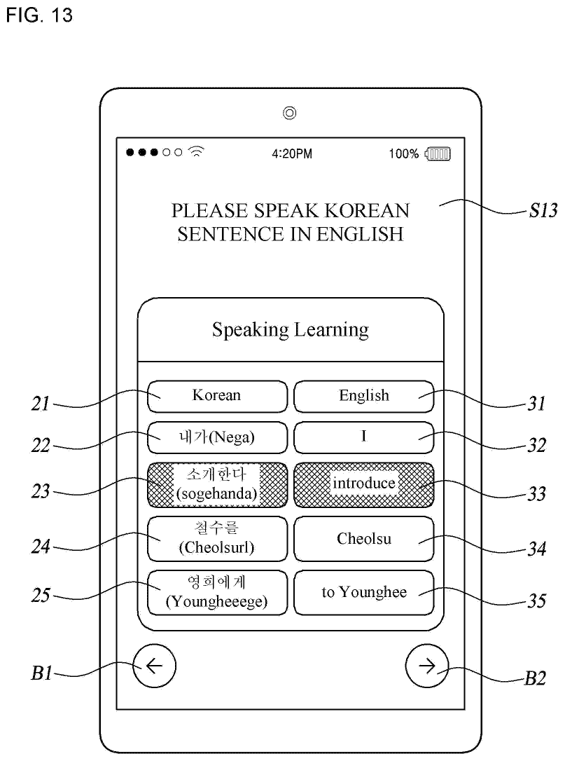

FIG. 13 is an example of an interface screen S13 being displayed after FIG. 12. In the interface screen S13, the foreign language, that is, English verb “introduce” corresponding to “ [symbol] (Sogehada)” displayed in FIG. 12 is displayed (the translation direction is set from the mother tongue word toward the corresponding foreign language word, not the pair of foreign language word and mother tongue word, i.e., the pair of mother tongue word and foreign language word).

Also, the corresponding information are filled in foreign language meaning filling information display parts 32, 34 and 35 corresponding to Korean meaning filling information display parts 22, 24, and 25. At this time, as an example described above, to reduce a burden of a learner, if possible, things which can display in Korean can be displayed in Korean. So, ‘ [symbol] (nega)’ is presented to ‘I’, ‘ [symbol] (cheolsurl) to ‘ [symbol] (cheolsu)’, and ‘ [symbol] (Youngheeege)’ to ‘to [symbol] (Younghee)’. Also, we can know that the necessary meaning filling information of the foreign language corresponding to the Korean of “ [symbol] (Sogehada)” are three.

In FIG. 13, the foreign language of “I”, not the mother tongue, is displayed on a display part 32 among the display parts of the foreign language meaning filling information. This is an example for controlling the level of difficulty and can be displayed as occasion demands or according to the user's setting or user's level selection.

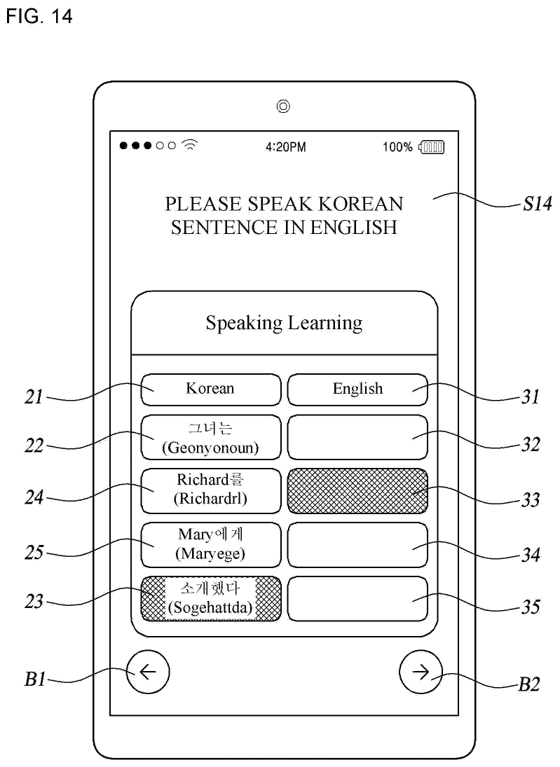

FIG. 14 is a view similar to FIG. 12 and also because it is a view for speaking practice, a specific word, in this example, the necessary meaning filling information using the word of “ [symbol] (Sogehada)” are displayed. That is, in the screen S12, the word of “ [symbol] (Sogehada)” is displayed on an input word display window 23 and the Korean (which means the mother tongue in the present invention) meaning filling information are displayed on each display parts 22, 24, and 25. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

In FIG. 14, display parts 22, 23, 24, and 25 of the mother tongue meaning filling information are typically displayed in the mother tongue (Korean language) word order from top to bottom, whereas display parts 32, 33, 34, and 35 of the foreign language meaning filling information are displayed in the corresponding foreign language word order from top to bottom. According to FIG. 14, a user can see and learn the Korean meaning filling information and the foreign language meaning filling information, simultaneously, when learning the foreign language. In order to speak Korean into English with the correct word order, a user can learn that he (or she) selects and processes the corresponding information by priority from the displayed Korean sentence through the process.

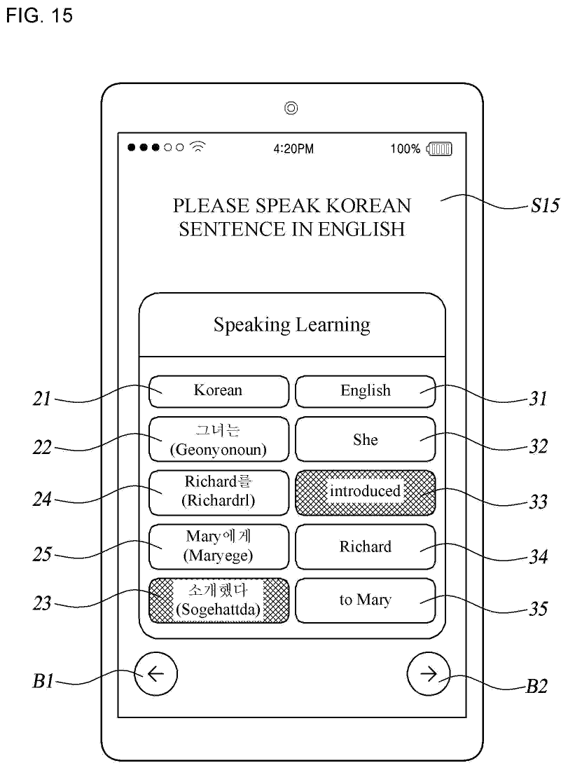

FIG. 15 is an example of an interface screen S15 being displayed after FIG. 14. FIG. 15 is displayed to the user being practiced in FIG. 14 as a practicing result. The user can see a screen the mother tongue meaning filling information display parts 22, 23, 24, and 25 and the corresponding foreign language (English) meaning filling information display parts 32, 33, 34, and 35 filled by foreign language words (She, introduced, Richard, to Mary) and simultaneously repeat easily English speaking in Korean sentence. The user can perform the English speaking learning by shifting from FIG. 14 to FIG. 15 or vice versa. In the above-mentioned review function, which is not shown, in case that a user selects a review function or a review button (not shown), the screens of FIG. 14 and FIG. 15 may be displayed repeatedly, thereby enhancing the learning effect.

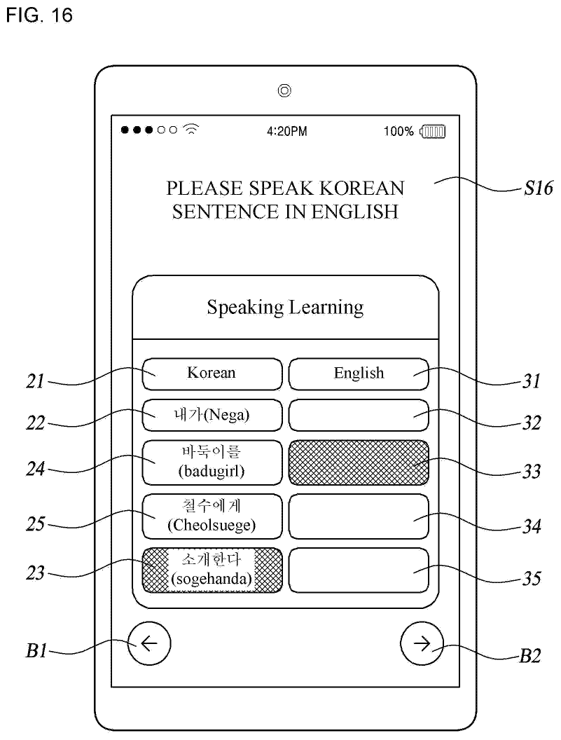

FIG. 16 is a view similar to FIG. 12 and also because it is a view for speaking practice, a specific word, in this example, the necessary meaning filling information using the word of “ [symbol] (Sogehada)” are displayed. That is, in the screen S16, the word of “ [symbol] (Sogehada)” is displayed on an input word display window 23 and the Korean (which means the mother tongue in the present invention) meaning filling information are displayed on each display parts 22, 24, and 25. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

In FIG. 16, display parts 22, 23, 24, and 25 of the mother tongue meaning filling information are typically displayed in the mother tongue (Korean language) word order from top to bottom, whereas display parts 32, 33, 34, and 35 of the foreign language meaning filling information are displayed in the corresponding foreign language word order from top to bottom. According to FIG. 16, a user can see and learn the Korean meaning filling information and the foreign language meaning filling information, simultaneously, when learning the foreign language. In order to speak Korean into English with the correct word order, a user can learn that he (or she) selects and processes the corresponding information by priority from the displayed Korean sentence through the process.

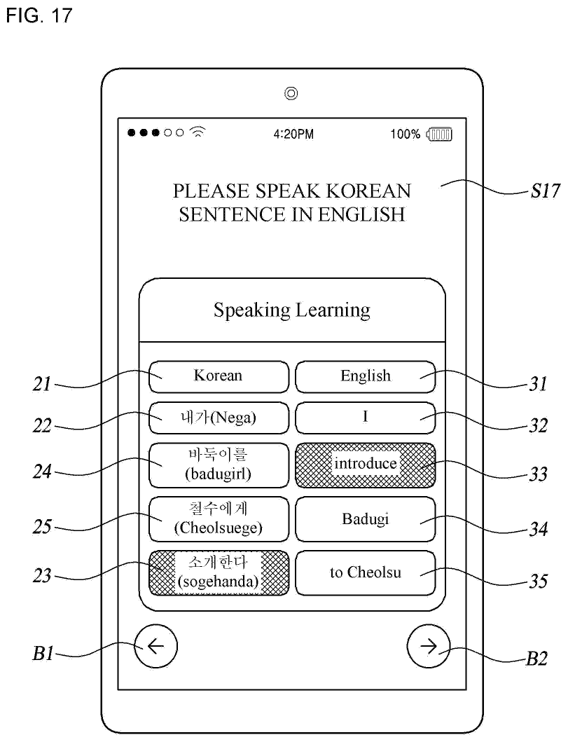

FIG. 17 is an example of an interface screen S17 being displayed after FIG. 16, which is similar to FIG. 13 and FIG. 15. In the interface screen S17, the foreign language, that is, English verb “introduce” corresponding to “ [symbol] (Sogehada)” displayed in FIG. 16 is displayed (the translation direction is set from the mother tongue word toward the corresponding foreign language word, not the pair of foreign language word and mother tongue word, i.e., the pair of mother tongue word and foreign language word).

Also, the corresponding information are filled in foreign language meaning filling information display parts 32, 34 and 35 corresponding to Korean meaning filling information display parts 22, 24, and 25. At this time, as an example described above, to reduce a burden of a learner, if possible, things which can display in Korean can be displayed in Korean. So, ‘ [symbol] (nega)’ is presented to ‘I’, ‘ [symbol] (badugirl) to ‘ [symbol] (badugi)’, and ‘ [symbol] (cheolsuege)’ to ‘to [symbol] (cheolsu)’. Also, we can know that the necessary meaning filling information of the foreign language corresponding to the Korean of “ [symbol] (Sogehada)” are three.

In FIG. 17, the foreign language of “I”, not the mother tongue, is displayed on a display part 32 among the display parts of the foreign language meaning filling information. This is an example for controlling the level of difficulty and can be displayed as occasion demands or according to the user's setting or user's level selection.

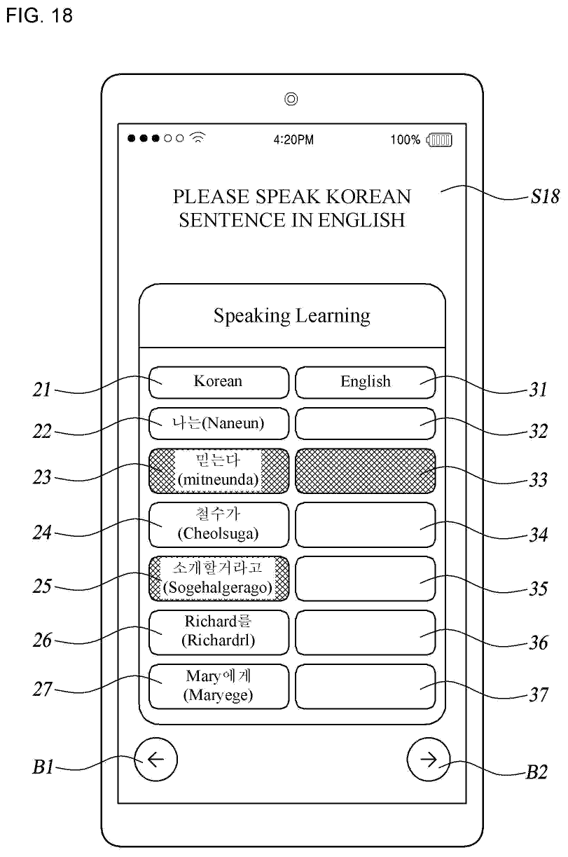

FIG. 18 is an example of an interface screen S18. FIG. 18 is a view similar to FIG. 12 and also because it is a view for speaking practice, a specific word, in this example, the necessary meaning filling information using the word of “ [symbol] (Sogehada)” are displayed. That is, in the screen S18, the word of “ [symbol] (Sogehada)” is displayed on an input word display window 23 and the Korean (which means the mother tongue in the present invention) meaning filling information are displayed on each display parts 22, 24, and 25. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

Although it is not shown, we know that empty parts excepting the display part 33 of the English display parts are five.

However, it does not mean that the meaning filling information of ‘ [symbol] (minunda)’ are five. Because the meaning filling information of ‘ [symbol] (minunda)’ are three and includes ‘to [symbol] (dongsa; verb)’ among three. Also, in ‘to [symbol] (dongsa; verb), the verb of ‘ [symbol] (sogehada)’ having three necessary meaning filling information is included to the position of [symbol] (dongsa; verb). Actually, in this example, when speaking the Korean sentence having two or more verbs in English sentence, a user can practice selection and speaking of the proper verb for instance. This is the high level of difficulty.

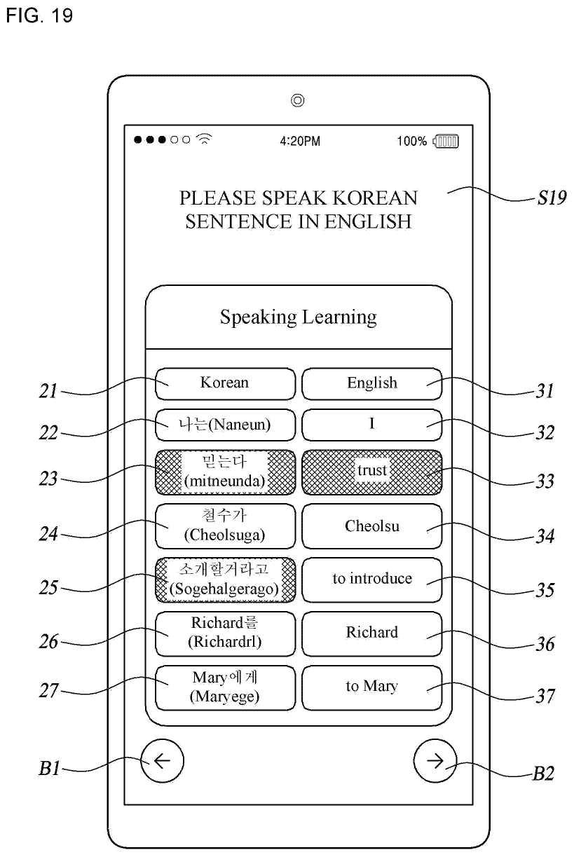

FIG. 19 is an example of an interface screen S19 being displayed after FIG. 18. FIG. 19 is displayed to the user being practiced in FIG. 18 as a practicing result. The user can see a screen the mother tongue meaning filling information display parts 22, 23, 24, and 25 and the corresponding foreign language (English) meaning filling information display parts 32, 33, 34, and 35 filled by foreign language words (I, trust, [symbol] (cheolsu), to introduce, Richard, to Mary) and simultaneously repeat easily English speaking in Korean sentence. The user can perform the English speaking learning by shifting from FIG. 19 to FIG. 18 or vice versa. In the above-mentioned review function, which is not shown, in case that a user selects a review function or a review button (not shown), the screens of FIG. 18 and FIG. 19 may be displayed repeatedly, thereby enhancing the learning effect.

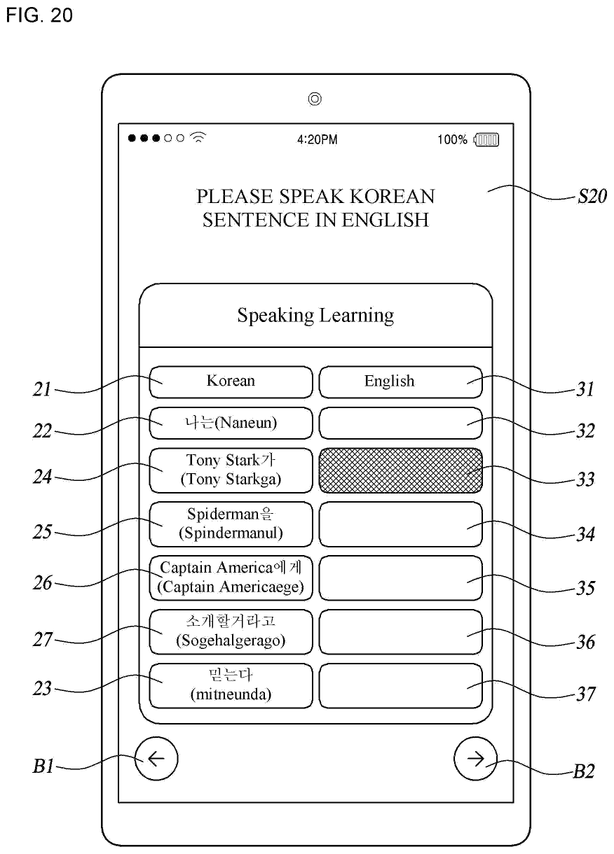

FIG. 20 is an example of an interface screen S20. FIG. 20 is a view similar to FIG. 12, FIG. 14, or FIG. 16 and also because it is a view for speaking practice, a specific word, in this example, the necessary meaning filling information using the word of “ [symbol] (minunda)” are displayed. That is, in the screen S20, the word of “ [symbol] (minunda)” is displayed on an input word display window 23 and the Korean (which means the mother tongue in the present invention) meaning filling information are displayed on each display parts 22, 24, 25, 26, and 27. However, the respective display parts 32, 34, and 35 of the corresponding foreign language meaning filling information are displayed as empty parts. The reference numbers B1 and B2 are buttons for moving each step toward right and left. The buttons may not necessary elements. That is, without buttons, after the constant elapsed time (about 3˜5 seconds), the screen can be shifted automatically by programming.

Although it is not shown, we know that empty parts excepting the display part 33 of the English display parts are five. However, it does not mean that the meaning filling information of ‘ [symbol] (minunda)’ are five. Because the meaning filling information of ‘ [symbol] (minunda)’ are three and includes ‘to [symbol] (dongsa; verb)’ among three. Also, in ‘to [symbol] (dongsa; verb), the verb of ‘ [symbol] (sogehada)’ having three necessary meaning filling information is included to the position of [symbol] (dongsa; verb). Actually, in this example, when speaking the Korean sentence having two or more verbs in English sentence, a user can practice selection and speaking of the proper verb for instance. Also, in this example, Korean verb parts have no color, which is different from FIG. 18, and so this is higher level of difficulty.

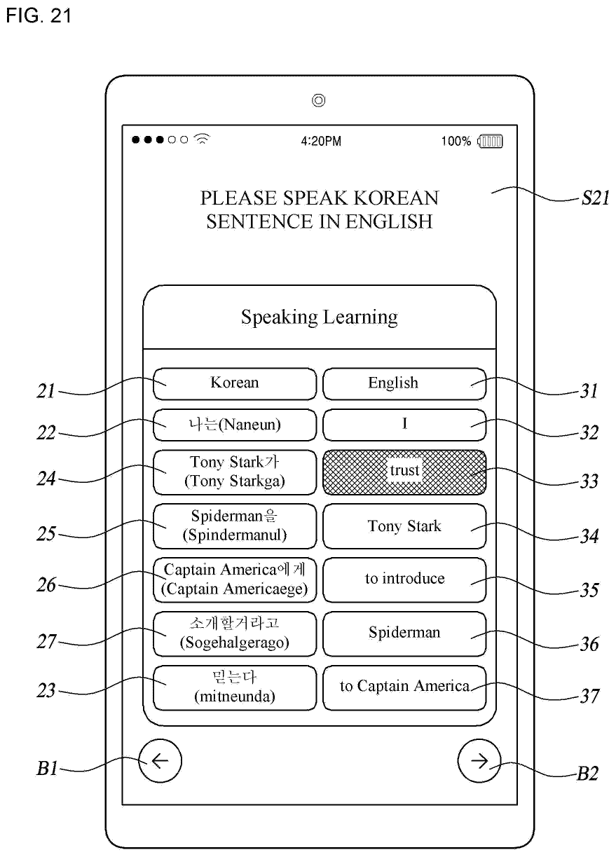

FIG. 21 is an example of an interface screen S21 being displayed after FIG. 20. FIG. 21 is displayed to the user being practiced in FIG. 20 as a practicing result. The user can see a screen the mother tongue meaning filling information display parts 22, 23, 24, 25, 26, and 27 and the corresponding foreign language (English) meaning filling information display parts 32, 33, 34, 35, 36, and 37 filled by foreign language (English) words (I, trust, Tony Stark, to introduce, Spiderman, to Captain America) and simultaneously repeat easily English speaking in Korean sentence. The user can perform the English speaking learning by shifting from FIG. 21 to FIG. 20 or vice versa. In the above-mentioned review function, which is not shown, in case that a user selects a review function or a review button (not shown), the screens of FIG. 20 and FIG. 21 may be displayed repeatedly, thereby enhancing the learning effect.

On the other hand, the present invention has been explained, for example, by using a personal digital assistant such as a smart phone terminal or an I-PAD to which a foreign language speaking verb learning program is downloaded. That is, the user uses the personal digital assistant in wireless communication environment such as WiFi to connect a foreign language speaking verb learning system server and can progress the progresses of FIG. 1 to FIG. 21. In the learning process, the user can upload data and store one's own learning data. Also, the user can inquiry and download the learning result for a certain period of time. Hereinafter, the connection processes to the foreign language speaking verb learning system server through the personal digital assistant will be explained with reference to the accompanying drawings.

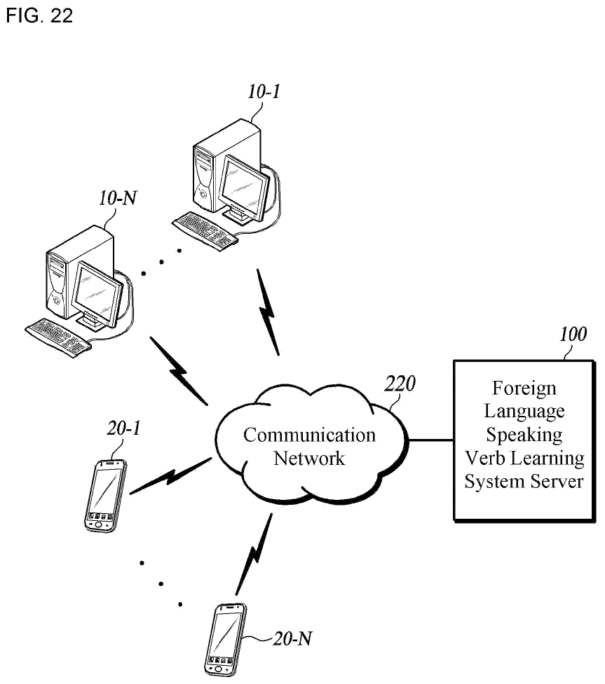

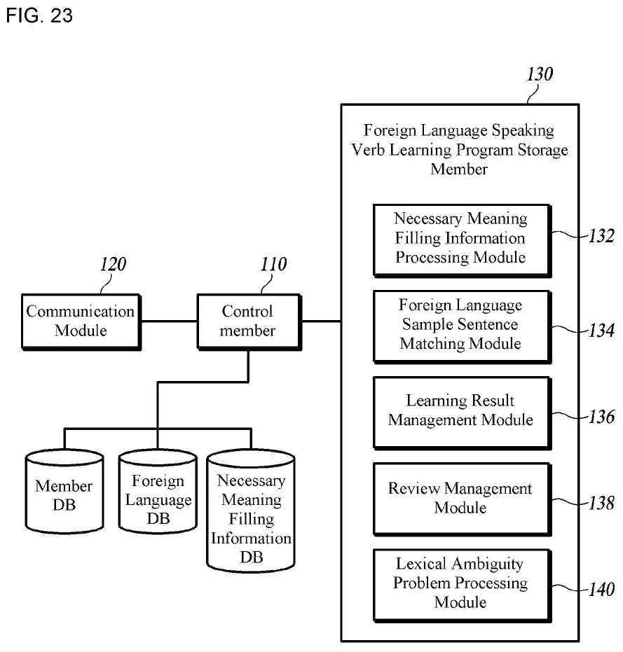

As shown in FIG. 22 and FIG. 23, the foreign language speaking verb learning system server for performing the foreign language speaking verb learning method according to the present invention consists of personal computer terminals 10-1, . . . , 10-N, smart phones 20-1, . . . , 20-N, and a foreign language speaking verb learning system server 100. A user connects to the foreign language speaking verb learning system server 100 by using smart phones 20-1, . . . , 20-N or personal computer terminals 10-1, . . . , 10-N through wire or wireless communication network 10.

As shown in FIG. 23, the foreign language speaking verb learning system server 100 includes a communication module 120, a control member 110, a foreign language speaking verb learning program storage member 130, a member database, a foreign language database, and a necessary meaning filling information database. The necessary mother tongue meaning filling information and the necessary foreign language meaning filling information are stored to the necessary meaning filling information database. The foreign language database can have a storage data including the mother tongue and the foreign language information (related to the necessary meaning filling information database), which is well-organized and can be easily looked up, corresponding to the mother tongue.

The foreign language database may be organized based on the mother tongue (however, it is not limited in that). For example, the most common foreign language words are organized based on the mother tongue. In a program, it may be organized by a look-up table type and memory addresses (in a computer program) corresponding to mother tongue to foreign language may be read by a control member (in this regard, it is well known in the field, so the detailed description will be omitted).

On the other hand, in FIG. 23, although several DBs are presented, they are examples and DBs are not limited to the examples. In FIG. 23, the necessary meaning filling information database DB are not fixed, and users can add one's own necessary meaning filling information DBs. Each DB is updated periodically and also may be updated automatically when performing a user's foreign language speaking learning. The library stored in the foreign language speaking learning program according to the present invention may be provided to each user's terminal. Whenever a user performs the foreign language speaking learning program, the user can search the library under the control of the program loaded within the user's terminal. Also, the user can search and process the DB from the server at the state that the user's terminal is connected to the server through a Network. According to the present invention, data generated during the foreign language speaking program (or application) working processes are uploaded in real time and processed, and the uploaded data may be processed and the processed whole data are used as big data.

The foreign language speaking verb learning program storage member 130 includes a necessary meaning filling information processing module 132, a foreign language sample sentence matching module 134, a learning result management module 136, a review management module 138, and a lexical ambiguity problem processing module 140.

The foreign language sample sentence matching module 134 can perform the searching process of the inputted word.

The foreign language sample sentence being matched with the word transmitted through the searching process to the inputted word may be displayed through the DB searching by the foreign language sample sentence matching module 134.

The necessary meaning filling information processing module 132 displays the necessary meaning filling information corresponding to the inputted word (verb). At this time, previously stored data about the corresponding word are searched from the DB and then the result data are displayed to the previously determined position (at this time, the determined position may be randomly set and displayed).

The lexical ambiguity problem processing module 140 discriminates a lexical ambiguity problem and also, searches and processes the lexical ambiguity problem through a separate lexical ambiguity problem DB.

When PC terminals 10-1, . . . , 10-N and smart phones 20-1, . . . , 20-N are connected with a communication module 120 of a foreign language speaking verb learning system server 100 through a communication network 220. When a learning request signal is inputted through the connected devices, under a control member 110 of the foreign language speaking verb learning system server 100, a necessary meaning filling processing module 132 and a foreign language sample sentence matching module 134 of a foreign language speaking verb learning program storage member 130 are worked. After the end of the learning, the learning result is managed by a learning result management module 136. When there is a request of review, a review process is managed by a review management module 138. On the other hand, a lexical ambiguity problem is processed selectively by working a lexical ambiguity problem processing module 140.

PC terminals 10-1, . . . , 10-N or smart phones 20-1, . . . , 20-N may perform a foreign language speaking verb learning program (or application) through a downloaded foreign language speaking verb learning program storage member 130.

On the other hand, FIG. 1 to FIG. 21 show illustrated sample screens which are processed by the foreign language speaking verb learning program (application) storage member 130. DBs of FIG. 23 may be stored to a program storage member of each device such as PC terminals 10-1, . . . , 10-N and smart phones 20-1, . . . , 20-N, partially.

As described above, optimum embodiments have been disclosed in the drawings and the specification. Herein, specific terms are used, but these are used for the purpose of describing the present invention only, but are not intended to limit the meaning thereof or the scope of the present invention described in the appended claims. Therefore, it will be understood by those skilled in the related art that various modified and equivalent embodiments may be made therefrom. Accordingly, the true technical protection scope should be defined by the technical spirit of the appended claims.

Unless otherwise defined, all terms including technical and scientific terms used herein have the same meaning as commonly understood by one of ordinary skill in the art to which this invention belongs. It will be further understood that terms, such as those defined in commonly used dictionaries, will be interpreted as having a meaning that is consistent with their meaning in the context of the relevant art and will not be interpreted in an idealized or overly formal sense unless expressly so defined herein.

1. A verb learning method for speaking foreign language through a personal terminal, which has a verb learning function for speaking foreign language and includes a verb learning program for speaking foreign language, a member database, a foreign language database, a necessary meaning filling information database,
wherein the verb learning method for speaking foreign language comprises the steps, which are performed by the verb learning program, of: searching the foreign language verb corresponding to a mother tongue verb when the mother tongue verb for speaking it in foreign language is inputted by an input device of the terminal, presenting necessary meaning filling information in the mother tongue verb, and presenting the foreign language verb corresponding to a mother tongue verb and the necessary meaning filling information in the foreign language verb corresponding to the necessary meaning filling information in the mother tongue verb.

2. A verb learning method for speaking foreign language through a personal terminal, which has a verb learning function for speaking foreign language and includes a verb learning program for speaking foreign language, a member database, a foreign language database, a necessary meaning filling information database,
Wherein the verb learning method for speaking foreign language comprises the steps, which are performed by the verb learning program, of:
searching the foreign language verb corresponding to a mother tongue verb when the mother tongue verb for speaking it in foreign language is inputted by an input device of the terminal,
discriminating whether a lexical ambiguity problem occurred because two or more foreign language verbs corresponding to the mother tongue verb exist,
presenting, in the first language, the meaning and the sample sentence about each candidate foreign language verb corresponding to the mother tongue verb inputted by a learner, if the lexical ambiguity problem occurred,
presenting necessary meaning filling information in the mother tongue verb, if a signal for selecting the contents corresponding the mother tongue verb is inputted from the learner, and
presenting the foreign language verb corresponding to a mother tongue verb and the necessary meaning filling information in the foreign language verb corresponding to the necessary meaning filling information in the mother tongue verb.

3. The verb learning method for speaking foreign language through a personal terminal according to claim 1, wherein the necessary meaning filling information includes one or more necessary sentence components, which necessarily must be included when making a sentence with a verb as a predicate, and the necessary meaning filling information in the foreign language verb corresponding to the necessary meaning filling information in the mother tongue verb are presented.

4. The verb learning method for speaking foreign language through a personal terminal according to claim 1, wherein the necessary meaning filling information is first presented by the components in the mother tongue and then by the foreign language components corresponding to the mother tongue information.

5. The verb learning method for speaking foreign language through a personal terminal according to claim 2, wherein in the presenting process of the meaning and the sample sentence, a type is presented additionally and separately as a non-language type like a picture to directly select a learner knowing the contents what he (or she) wants to speak, thereby solving a lexical ambiguity problem.

6. A verb learning method for speaking foreign language through a personal terminal, which has a verb learning function for speaking foreign language and includes a verb learning program for speaking foreign language, a member database, a foreign language database, a necessary meaning filling information database,
wherein the verb learning method for speaking foreign language comprises the steps, which are performed by the verb learning program, of:
searching the foreign language verb corresponding to a mother tongue verb when the mother tongue verb for speaking it in foreign language is inputted by an input device of the terminal,
discriminating whether a lexical ambiguity problem occurred because a structure of the meaning filling information of the mother tongue verb is two or more,
presenting, in mother tongue, the information about the two or more structures of the meaning filling information, if the lexical ambiguity problem occurred,
presenting necessary meaning filling information in the mother tongue verb, if a signal for selecting the contents, which a learner wants to speak, corresponding the meaning filling information structure of the mother tongue verb is inputted from the learner, and
presenting the foreign language verb corresponding to a mother tongue verb and the necessary meaning filling information in the foreign language verb corresponding to the necessary meaning filling information in the mother tongue verb.

7. A program stored to a memory medium which readable by a digital device such as a computer including a verb learning method for speaking foreign language according to claim 1.

8-9. (canceled)

10. The verb learning method for speaking foreign language through a personal terminal according to claim 2, wherein the necessary meaning filling information includes one or more necessary sentence components, which necessarily must be included when making a sentence with a verb as a predicate, and the necessary meaning filling information in the foreign language verb corresponding to the necessary meaning filling information in the mother tongue verb is presented.

11. The verb learning method for speaking foreign language through a personal terminal according to claim 2, wherein the necessary meaning filling information are first presented by the components in the mother tongue and then by the foreign language components corresponding to the mother tongue information.

12. A program stored to a memory medium which readable by a digital device such as a computer including a verb learning method for speaking foreign language according to claim 2.

13. A program stored to a memory medium which readable by a digital device such as a computer including a verb learning method for speaking foreign language according to claim 6.
